(19) United States
(12) Patent Application Publication
(10) Pub. No.: US 2007/0057164 A1
(43) Pub. Date: Mar. 15, 2007

(54) Scheimpflug normalizer

(76) Inventors: David Vaughnn, Edina, MN (US); Mark Harless, Plymouth, MN (US)

Correspondence Address: DICKE BILLIG & CZAJA, PLLC;ATTN: CHRISTOPHER MCLAUGHLIN, 100 SOUTH FIFTH STREET, SUITE 2250, MINNEAPOLIS, MN, 55402, US

(21) Appl. No.: 11/522,060

(22) Filed: Sep. 15, 2006

Related U.S. Application Data
(60) Provisional application No. 60/717,675, filed on Sep. 15, 2005.

(51) Int. Cl. H01J 3/14; H01J 40/14; H01J 5/16

(52) U.S. Cl. 250/216

(57) ABSTRACT

An imaging system for capturing images of a tilted object includes a lens having an optical axis, a detector array, and a normalizer positioned between the lens and a detector array for realigning light passing therethrough such that the Scheimmpflug condition with respect to the tilted object being imaged is satisfied and light is incident upon the detector array in a substantially normal orientation.

### CROSS-REFERENCE TO RELATED APPLICATION

This application claims priority under 35 U.S.C. §119(e)(1) to U.S. Provisional Patent Application Ser. No. 60/717,675, filed Sep. 15, 2005, entitled “Scheimpflug Normalizer”, and bearing Attorney Docket No. A126.190.101.

### TECHNICAL FIELD OF THE INVENTION

The present invention relates generally to optical components.

### BACKGROUND OF THE INVENTION

In the optical arena, it is difficult to capture an image of an object that is tilted with respect to the optical axis of a camera. As different portions of a tilted object are at different distances from the image capturing component of the camera, the image projected onto the film or detector array of the camera is also tilted such that portions of the image will fall outside the depth of focus of the camera. This results in blurry images or portions of images.

One solution to the problem found of capturing tilted objects is shown in FIG. 1. FIG. 1 includes camera 100, object 102, and object plane 104. Camera 100 further includes lens 106, lens plane 108, film or detector array (image capturing component) 110, detector array plane 112, optical axis 114, and interection point 116. As shown in FIG. 1, minimizing the portions of an image which falls outside the depth of focus of camera 100 is achieved by tilting detector array 110 of camera 100 with respect to the optical axis 114 of lens 106 such that a condition referred to as the Scheimpflug condition or principle is achieved. Briefly, according to the Scheimpflug principle, focus and optimal depth-of-field are achieved when object plane 104 of object 102 being imaged, lens plane 108 of lens 106, and the image capturing component plane or detector array plane 112 of detector array 110 intersect at the same point, shown as intersection point 116 in FIG. 1. In other words, by tilting detector array 110 within camera 100 with respect to object 102 being imaged so that object plane 104, lens plane 108, and detector array plane 112 all intersect at intersection point 116, thereby satisfying the Scheimpflug principle, the amount of object 102 that is brought into the depth of focus of camera 100 is maximized. Thus, the resulting image recorded on detector array 110 are improved.

While in most instances tilting the detector array of a camera is a readily accessible solution, doing so tilts the local optical axis with respect to the detector array. Because microlens arrays require incident light to be within a relatively narrow cone of acceptance that is substantially normal to the detector array and because a large percentage of detector arrays in use today utilize microlens arrays, the local tilt of the optical axis required to satisfy the Scheimpflug condition can result in significant reductions in the efficiency and resolution of these detector arrays. As seen in FIG. 7, where a detector array 190 includes a microlens array 192, much of the light incident on the detector array 190 will not reach the intended or target sensitive areas 194 of the detector array 190. Instead, significant portions of light rays 196 incident on the microlens array 192 at an angle outside the angle of acceptance of the detector array will be reflected, absorbed or otherwise directed to locations on the microlens array 190 other than the intended or target sensitive areas 194, resulting in dark or low contrast images that are often unacceptable for use in many applications. Accordingly, there is a need for a solution to this problem of poor illumination when detector arrays 190 of a camera are tilted to satisfy the Scheimpflug condition.

### SUMMARY

An imaging system for capturing images of a tilted object includes a lens having an optical axis, a detector array, and a normalizer positioned between the lens and a detector array for realigning light passing therethrough such that the Scheimpflug condition with respect to the tilted object being imaged is satisfied and light is incident upon the detector array in a substantially normal orientation.

### BRIEF DESCRIPTION OF THE DRAWINGS

FIG. 1 is a schematic drawing of an optical system illustrating the Scheimpflug principle.

FIG. 2 is a schematic drawing of a prior art optical system wherein the object is tilted with respect to an optical axis of a lens.

FIG. 3 is a schematic drawing of an optical system illustrating a detector array that is tilted with respect to a local optical axis such that the Scheimpflug principle is satisfied.

FIG. 4 is a schematic drawing of an optical system illustrating a tilted detector array adapted to capture images at an edge portion of a semiconductor wafer.

FIG. 5 is a schematic drawing illustrating a detector array mounted on a rotatable base.

FIG. 6 is a schematic drawing illustrating a detector array mounted on an interchangeable mounting block.

FIG. 7 is a schematic drawing of a detector array illustrating light rays projecting at an angle to a detector array which may not pass through a typical prior art microlens array to fall on the light sensitive areas of the detector array.

FIG. 8 is a schematic drawing illustrating an offset microlens array wherein the microlenses are laterally offset with respect to the target sensitive areas of the detector array, so as to permit substantially all light incident on the array of microlenses to be directed to the target sensitive areas of the detector array where the detector array is tilted with respect to an object being imaged so as to satisfy the Scheimpflug condition.

FIG. 9 is a schematic drawing of an optical system illustrating a normalizer positioned between an object and an imager.

FIG. 10 is a schematic drawing illustrating a normalizer comprising a simple prism positioned between a lens and an imager.

FIG. 11 is a schematic drawing of an optical system illustrating a normalizer for re-aligning light passed therethrough such that the light is incident upon a detector array in a near normal manner and wherein the detector array is tilted with respect to an edge portion of a semiconductor wafer in a manner that satisfies the Scheimpflug principle.

FIG. 12 is a schematic drawing of an optical system that satisfies the Scheimpflug principle and wherein light is directed to the optical system by a turning mirror.

FIG. 13 is a schematic drawing of an optical system that satisfies the Scheimpflug principle and wherein light is directed to the optical system by a turning mirror.

FIG. 14A is a schematic drawing of an optical system having multiple illuminators arranged to direct light onto a diffuser that is positioned at an angle to a radius of a semiconductor wafer edge and a camera assembly adapted to receive light reflected from a semiconductor wafer such that the object represented by the reflected light is tilted with respect to a detector array of the camera assembly.

FIG. 14B is a schematic drawing of a camera positioned normal to an edge of a semiconductor wafer.

FIG. 15 is a schematic drawing illustrating multiple illuminators arranged to direct light onto a diffuser positioned about a semiconductor wafer.

### DETAILED DESCRIPTION

In the following detailed description of the invention, reference is made to the accompanying drawings that form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. The following detailed description is, therefore, not to be taken in a limiting sense, and the scope of the present invention is defined only by the appended claims and equivalents thereof.

As used herein, the term “detector array” includes, but is not limited to, image capturing components or systems such as standard camera film and digital imaging sensors such as CCD sensors, CMOS sensors, and other similar sensors or devices. Furthermore, the term ‘detector array’ also includes, but is not limited to, any type of color, grey scale, or intensity sensors capable of capturing images or image data using a single or multiple types of illumination including brightfield, darkfield, and laser illumination.

FIG. 1 is a schematic drawing of an optical system illustrating the Scheimpflug principle or condition. According to the Scheimpflug principle, focus of an image, and optimal depth-of-field are achieved when the object plane of an object being imaged, the lens plane of the lens of a camera, and the image capturing component plane or detector array plane of a detector array all intersect at the same point, known as the intersection point. By satisfying the Scheimpflug principle, it is possible to keep in focus an object, or portions of an object, tilted with respect to an optical axis of a camera.

FIG. 1 includes camera 100, object 102, and object plane 104. Camera 100 further includes lens 106, lens plane 108, film or detector array (image capturing component) 110, detector array plane 112, optical axis 114, and intersection point 116. As shown in FIG. 1, object plane 104 of object 102, lens plane 108 of lens 106, and detector array plane 112 of detector array 110 intersect at intersection point 116. Thus, by tilting detector array 110 of camera 100 with respect to object 102 so as to satisfy the Scheimpflug principle, the amount of object 102 that is brought into the depth of focus of camera 100 is maximized and the resulting images recorded by detector array 110 are improved.

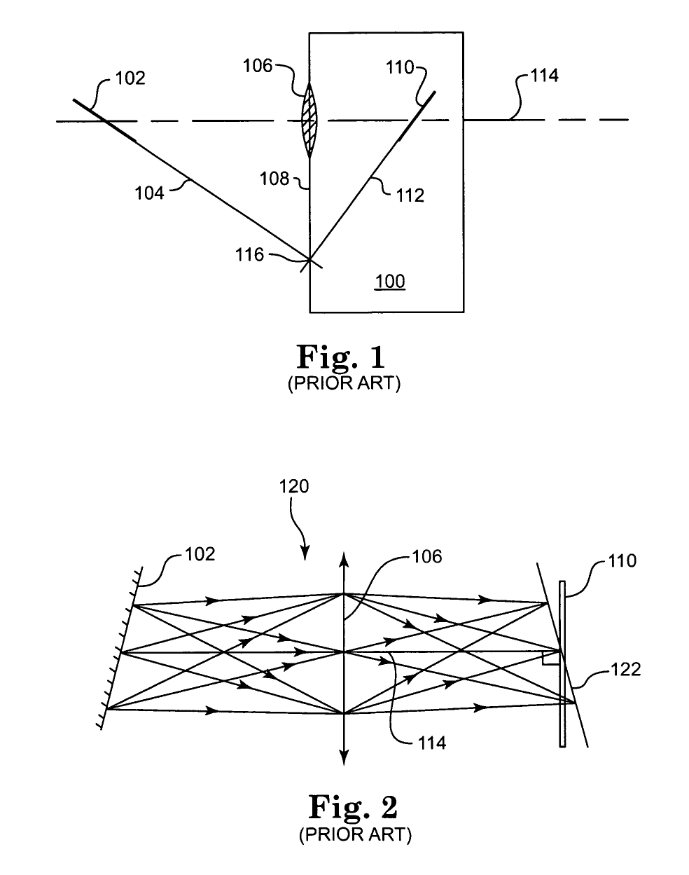

FIG. 2 schematically illustrates prior art optical system 120 wherein object 102 is tilted with respect to optical axis 114 of lens 106, while detector array 110 is normal to optical axis 114 of lens 106. Specifically, object 102 is not normal to optical axis 114 of lens 106. Therefore, image 122 is not properly aligned with detector array 110 to optimize the depth of focus of the optical device and portions of image 122 will fall outside the depth of focus of the optical device incorporating this design. With misalignment of detector array 110 and image 122, blurry images or portions of images result.

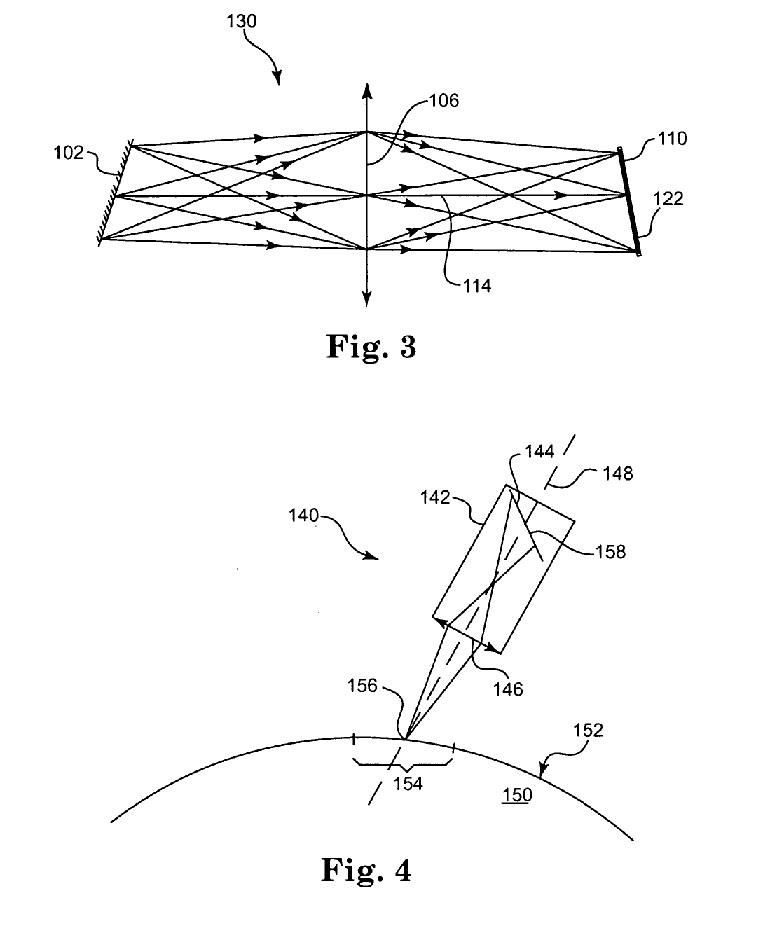

FIG. 3 is a schematic drawing of optical system 130 illustrating detector array 110 tilted with respect to optical axis 114 of lens 106 such that the Scheimpflug principle is satisfied. In FIG. 3, object plane 104, lens plane 108, and detector array plane 112 are not shown for clarity purposes. However, it is understood that if these planes were shown, they would all intersect at a single point substantially above the optical system shown in FIG. 3, thereby illustrating the satisfaction of the Scheimpflug principle.

As show in FIG. 3, image 122 and detector array 110 are substantially coincident. Therefore, optical system 130 will capture image 122 substantially or maximally in focus. In one embodiment, detector array 110 of optical system 130 may include a bare detector array, i.e., a detector array having no grating, pinhole array, or array of microlenses associated therewith. Further, in one embodiment detector array 110 may be tilted within the body of a camera (not shown) for use, for example, in an industrial setting for capturing images of objects tilted with respect to optical axis 114 of lens 106.

FIG. 4 is a schematic drawing of optical system 140 illustrating tilted detector array 144 adapted to capture images of edge portion 152 of semiconductor wafer 150. In one embodiment, edge portion 152 may solely include the edge semiconductor wafer 150. In another embodiment, edge portion 152 may include the edge of semiconductor wafer 150 and/or outer radial portions of the top and/or bottom portions of semiconductor wafer 150.

As shown in FIG. 4, camera 142 is arranged to capture images of edge portion 152 of semiconductor wafer 150. Camera 142 includes lens 146, detector array 144, and optical axis 148. Camera 142 may be coupled to a controller (not shown) that receives and processes image data from camera 142 in a known fashion. Note that in this embodiment, field of view 154 of semiconductor wafer 150 encompasses a curvilinear portion of edge portion 152 of semiconductor wafer 150. However, as field of view 154 of wafer edge portion 152 is relatively small in relation to the entire edge surface of semiconductor wafer 150, object 156 over field of view 154 can be characterized as a substantially flat surface. Accordingly, detector array 144 of camera 142 is tilted with respect to optical axis 148 of lens 146 in direct relation to the substantial plane of object 156 such that the plane of detector array 144, the plane of lens 146, and the plane of object 156 all intersect at a single intersection point (not shown in FIG. 4 for clarity purposes), thereby satisfying the Scheimpflug principle. As illustrated, with the Scheimpflug principle satisfied, image 158 of object 156 is substantially co-incident with detector array 144 and accordingly, substantially or at least maximally in focus. However, as described above, where the detector array 158 includes a microlens array, degraded efficiency and contrast in the resulting images may occur as a result of the tilt of the detector array 158 with respect to the local optical axis.

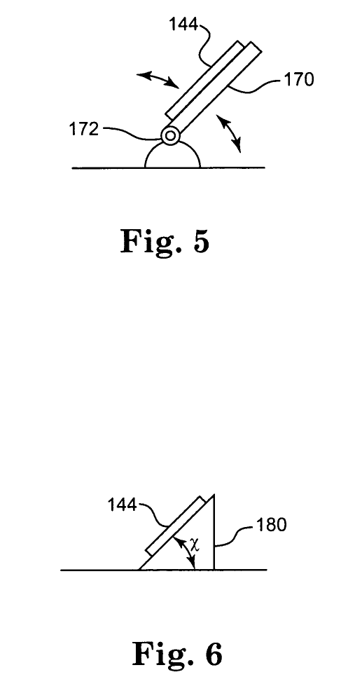

FIG. 5 is a schematic drawing illustrating a detector array mounted on a rotatable base, while FIG. 6 is a schematic drawing illustrating a detector array mounted on an interchangeable mounting block. As will be appreciated, the angle of detector array 144 with respect to optical axis 148 is conditional and specific to the angle of tilt of object 156. Accordingly, as shown in FIG. 5, in one embodiment detector array 144 is mounted on hinged plate 170 coupled to rotatable mechanism 172. It is understood that hinge plate may be secured in a number of positions and angles such that, depending on the angle of the object to be captured, the Scheimpflug principle is satisfied. In FIG. 6, detector array 144 is mounted on one of a number or interchangeable mounting blocks 180, one of which is illustrated in FIG. 6. Each mounting block 180 has an angle x that is adapted to satisfy the Scheimpflug principle, depending on the angle of the object to be captured. It will be appreciated that the mounting blocks 180 having different angles x and are interchangeable with one another so as to satisfy the Scheimpflug principle.

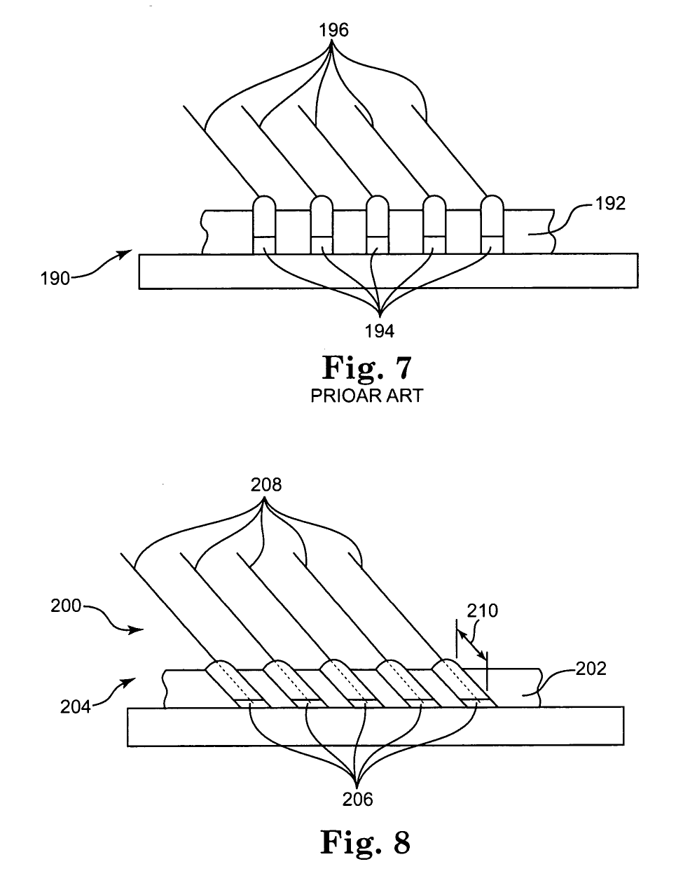

FIG. 7 is a schematic view of a detector array 190 illustrating how light incident on a detector array 190 at an angle outside a range or cone of acceptance angles of a microlens array 192 of the detector array 190 may not fall on the intended or target light sensitive areas of detector array 190. Many off-the-shelf cameras utilize detector arrays 190 that incorporate integral microlens arrays 192 that concentrate light and direct the light to light sensitive areas 194 of the array where the light is incident on the array at a near normal angle or at least within a cone of acceptance angles that is defined by the optical properties of the microlenses themselves. Where a significant portion of the light rays 196 incident on the microlens array 192 are at an angle outside the angle of acceptance of the detector array, these light rays will be reflected, absorbed or otherwise directed to locations on the microlens array 190 other than the intended or target sensitive areas 194, resulting in dark or low contrast images that are often unacceptable for use in many applications.

FIG. 8 is a schematic view of an embodiment of a normalizer 200 where an integral array of microlenses 202 are laterally offset with respect to sensitive areas 206 of a detector array 204. In this embodiment, detector array 204 may be tilted with respect to an object being imaged (not shown) so as to satisfy the Scheimpflug condition. But, because microlens array 202 is laterally offset with respect to sensitive areas 206 of detector array 204, light rays 208 from the object (not shown) will pass through the lenses of the array 204 and be incident upon the target sensitive areas 206, respectively. The angle of the offset 210 is such that light rays 208 are incident upon array 204 within the array's cone of acceptance, thereby permitting sufficient light to reach the sensitive areas 206 of detector array 204 and simultaneously satisfying the Scheimpflug condition with respect to the object (not shown) being imaged.

As described above, microlens arrays are usually formed integral to a detector array. Accordingly, in many embodiments, a normalizer will be formed independent of the microlens array. In other embodiments, it is possible to combine the normalizer with a microlens array.

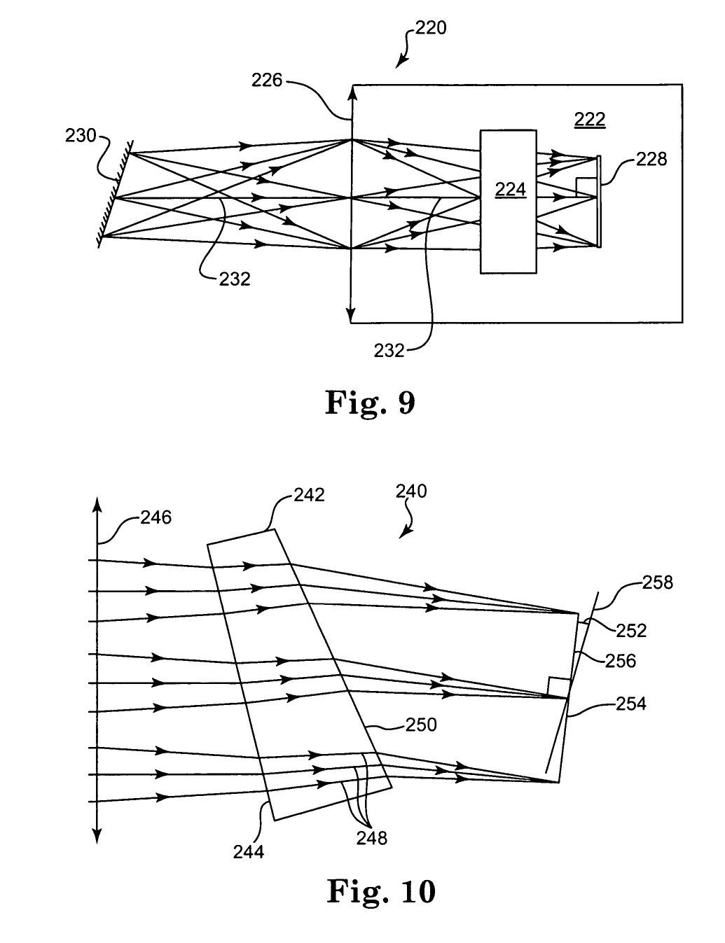

FIG. 9 is a schematic drawing illustrating optical system 220 which includes normalizer 224 interposed between lens 226 of camera 222 and a detector array 228, which detector array may include an integral microlens array (not shown). As shown in FIG. 9, object 230 is tilted with respect to optical axis 232. Normalizer 224 refracts or diffracts light passing therethrough so as to ensure both that light emanating therefrom is incident upon detector array 228 in a manner that substantially satisfies the Scheimpflug principle and that light is incident upon the detector array 228 at an angle that is substantially within the cone of acceptance of the detector array. Note that in FIG. 9 light is shown as being incident on the detector array 228 at 90° to the array, but it is to be understood that the detector array may be angled with respect to the local optical axis so long as the angle is not so great as to take the incident light out of the cone of acceptance of the detector array. Normalizer 228 may be adapted to accommodate light that is monochromatic or achromatic. Examples of optical components that may be used to form suitable normalizer 228 may include, but are not limited to, simple prisms, complex prisms, gratings, grisms, microlens arrays, and any other suitable optical component and/or combinations thereof.

As can be seen in FIG. 9, in this embodiment, the detector array 228 is normal to optical axis 234 or lens 226 of camera 222 and it is therefore possible to use common, off-the-shelf digital and analog cameras having fixed orientation detector arrays. By modifying the optical characteristics of the normalizer 242, this normal or near normal arrangement can be maintained while still substantially satisfying the Scheimpflug condition, thereby allowing the use of off, the shelf components as described above.

It should be understood that the very nature of the normalizer 242 will modify the conditions of how the Scheimpflug condition are to be met. Under normal conditions, the Scheimpflug condition is satisfied where the image and object planes intersect at the lens plane. Introducing an optical element such as the normalizer 242 into the optical path may result in a physical arrangement of the detector array 254 with respect to the lens 246 that would not, in the absence of the normalizer 242, satisfy the Scheimpflug condition. Nevertheless, taking into consideration the modification of the optical path by the normalizer 242, the optical system 220 will substantially satisfy the Scheimpflug condition as well as provide for illumination to be incident upon the detector array 228 at an angle that is within the detector array's angle or cone of acceptance and preferably at or near normal incidence.

In another embodiment, an optical system similar to that illustrated in FIG. 9 and which incorporates a normalizer 224 may be adapted for use in surveillance applications. In practice, the object 230, rather than being a small item such as a semiconductor wafer, may be an area requiring constant surveillance such as an airport concourse or the like or more specifically, the faces and bodies of persons in the area under surveillance. Use of the normalizer 224 would facilitate the collection of higher quality images as described hereinabove. In embodiments such as this one, lenses that provide for a large field of view, to provide for surveillance of a larger area, may be desirable. In any case, it is likely that with the use of the present invention in surveillance applications, more and better images of persons, autos, or objects in a given area will be obtained as compared to prior art.

FIG. 10 illustrates a particular embodiment of optical system 240 including normalizer 242 that is embodied in a simple prism. Normalizer 242 of this embodiment has front face 244 that is angled with respect to lens 246. Light is received into normalizer 242 through the front face 244 and diffracted as shown by light rays 248. Light exits normalizer 242 through rear face 250 thereof and is again diffracted. Light exiting normalizer 242 is incident upon detector array 252. Where normalizer 242 is used, detector array 252 may be arranged normally or substantially normally to local optical axis 254. In some circumstances, detector array 252 may also be tilted somewhat so long as the Scheimpflug condition is met and sufficient rays 248 of light may pass through the microlens array 202 (shown in FIG. 8) to be incident on the sensitive areas 206 (shown in FIG. 8) of detector array 252. With the Scheimpflug principle satisfied, image 256 is substantially co-incident with detector array 252 and accordingly, substantially or at least maximally in focus. Conversely, without normalizer 242, image 258 would result, which is no co-incident with detector array 252, and thus would not be substantially or at least maximally in focus.

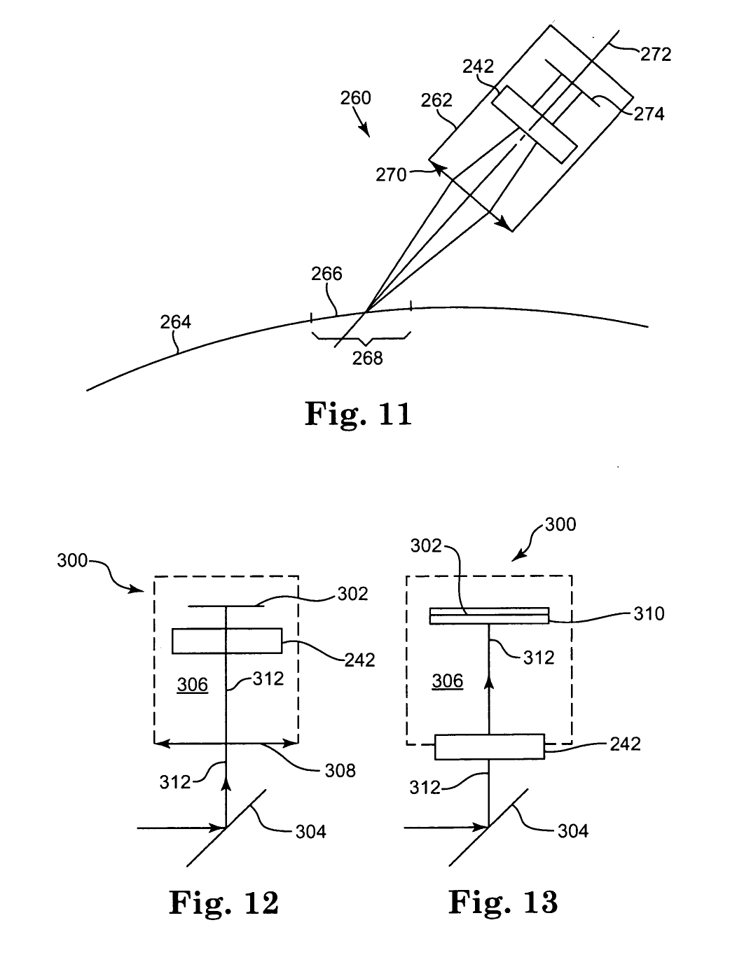

FIG. 11 is a schematic drawing of optical system 260. Optical system 260 includes camera 262, wafer 264, wafer edge portion 266, and field of view 268. Camera 262 further includes normalizer 242, lens 270, optical axis 272, and detector array 274. As shown in FIG. 11, normalizer 242 is positioned between lens 270 and detector array 274. Examples of optical components that may be used to form normalizer 242 may include, but are not limited to, simple prisms, complex prisms, gratings, grisms, microlens arrays, and any other suitable optical component and/or combination thereof. As can be seen in FIG. 11, detector array 242 is normal to optical axis 272 of lens 270 of camera 262, it is possible to use, off-the-shelf digital and analog cameras having fixed orientation detector arrays. Normalizer 242 reflects or diffracts light passing therethrough so as to ensure that light emanating therefrom is incident upon detector array 274 in a manner that substantially satisfies the Scheimpflug principle and ensures that light incident upon the detector array is substantially within the cone of acceptance of the detector array. Normalizer 242 may be adopted to accommodate light that is monochromatic or achromatic. Through utilization of normalizer 242, optical system 260 is capable of capturing images from wafer edge portion 266 of wafer 264 such that substantial focus and optimal depth of field are achieved without the requirement of a tilted detector array 274, as was necessary with optical system 140 shown in FIG. 4.

FIGS. 12 and 13 are schematic drawings of optical system 300 that satisfies the Scheimpflug principles, wherein light is directed to camera 306 by one or more turning mirrors 304. In FIG. 12, camera 306 includes lens 308 and detector array 302. Normalizer 242 may be used in conjunction with other optical components such as turning mirror 304 so that detector array 302 may be oriented normal to optical axis 312, as shown in FIGS. 12 and 13.

It is understood that while a single turning mirror 304 is shown in FIGS. 12 and 13, multiple turning mirrors 304 may be included in optical system 300 without deviating from the present invention. Turning mirrors 304 may be used to bend or reflect light in multiple directions as necessary. In FIG. 13, a similarly oriented camera 306 excludes lens 308 and relies on the combination of microlens array 310 to and normalizer 242 to concentrate and direct light towards detector array 302.

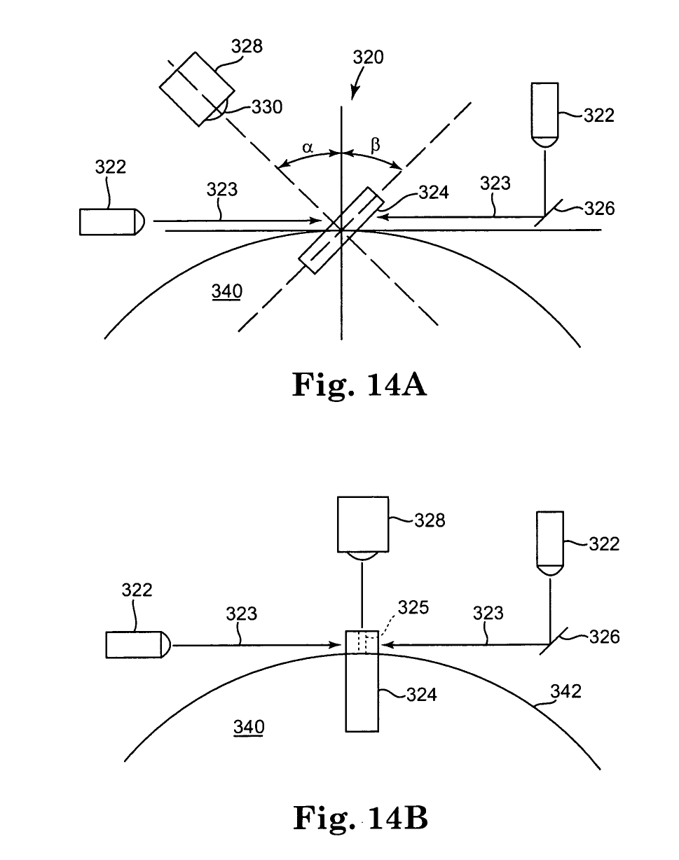

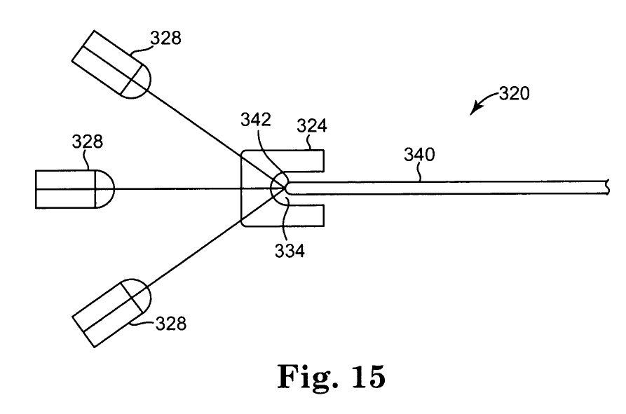

FIGS. 14A, 14B, and 15 are schematic drawings of optical system 320 that may incorporate a tilted detector array (not shown in FIGS. 14A, 14B, and 15) described in conjunction with FIGS. 3, 4, 8, 12, and 13 within camera 328. Optical system 320 includes one or more illuminators 322 that output light, shown in FIG. 14A as light rays 323, that is incident upon diffuser 324. In some embodiments illuminators 322 are arranged to emit light directly onto the diffuser 324, while in other embodiments, the light, represented by light ray 323, is directed from illuminators 322 to diffuser 324 by turning mirror 326. Turning mirror 326 may consist of a mirror, a reflecting device, a MEMs device, or a beamsplitter. Turning mirror 326 may be a transmissive object, may be flat or complex in shape, and may act as a normalizer or a port of a normalizer. While only one turning mirror 326 is shown in FIG. 14A, it is understood that multiple turning mirrors may be included in optical system 320. In one embodiment, multiple turning mirrors 326 may be incorporated to bend light from a single illuminator 322, due to space and design criteria of optical system 320.

Light is then passed through aperture 330 of camera 328 where images of semiconductor wafer 340 are captured. Note that diffuser 324 has slot 334 formed therein for receiving edge portion 342 of the semiconductor wafer 340. Note also that diffuser 334 may be positioned at any suitable angle with respect to edge 342 of semiconductor wafer 340. In one embodiment, the diffuser 324 is aligned at an acute angle to a radius of the semiconductor wafer. In some embodiments, the camera 328 and/or turning mirror 326 will be adapted to receive light at an angle that is substantially the same as the angle at which the diffuser 324 is arranged with respect to a radius of the wafer. However, the light will be received through the opposite side of the radius as illustrated schematically in FIG. 14A, i.e., in a situation where angle α is substantially the same as angle β. As shown in FIG. 14A, diffuser 324 is positioned at an angle α to a radius of wafer 340, and camera 328 is positioned at an angle β to the same radius of wafer 340 opposite angle α.

Note that in FIG. 14A, illuminators 322 directly emit or direct light onto the diffuser 324 in addition to, or in some instances to the exclusion of, illuminating the wafer edge portion 342. The light emitted by illuminators 322 may be monochromatic or achromatic. Note that in FIG. 14A, camera 328 and illuminators 322 are located in the same or substantially the same plane as the semiconductor wafer 340. In other embodiments, one example of which is illustrated in FIG. 15, some cameras 328 may be placed out of the plane of wafer 340. Illumination may be provided to wafer edge portion 342, with or without the use of a diffuser 324, so long as sufficient brightfield and darkfield illumination is reflected into camera 328, in a specular fashion with respect to brightfield illumination and in a scattered fashion with respect to darkfield illumination.

FIG. 14B is a schematic drawing illustrating camera 328 positioned normal to edge 342 of semiconductor wafer 340. As shown in FIG. 14B, camera 328 is capable of peering edge portion 342 of semiconductor 340 through aperture 325 in diffuser 324.

Also, as suggested by FIG. 15, multiple cameras 328 may be positioned so as to receive both brightfield and darkfield illumination from illuminators 322 (not shown in FIG. 15 for clarity purposes). Similarly, any number of illuminators may be used to achieve a suitable intensity of brightfield and darkfield illumination. Alternatively, camera 328 of a type described hereinabove may be mounted on a moveable armature (not shown) of a type known to those skilled in the art, that is capable of moving camera 328 between the positions suggested by FIG. 15 such that all aspects of the edge portion 342 and some portions of the top and bottom of the semiconductor wafer may be imaged by camera 328 by a single camera. As can be readily imagined, multiple cameras 328 may be also used on such an armature.

### CONCLUSION

Although specific embodiments of the present invention have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any adaptations or variations of the invention. It is manifestly intended that this invention be limited only by the following claims and equivalents thereof.

1. An imaging system for capturing images of a tilted object comprising:
a detector array having a microlens array, the detector array tilted with respect to an optical axis of the imaging system and positioned to receive light passed through the detector array, an angle of tilt of the detector array being related to an angle of tilt of the object being imaged.

2. The imaging system for capturing images of a tilted object of claim 1, wherein the angle of the detector array satisfies the Scheimpflug principle with respect to the tilted object.

3. The imaging system for capturing images of a tilted object of claim 1, and further comprising:
a lens.

4. The imaging system for capturing images of a tilted object of claim 3, wherein a lens plane, an object plane, and a detector array plane all intersect at a single intersection point.

5. The imaging system for capturing images of a tilted object of claim 1, wherein the detector array further comprises:
an array of sensitive areas; and
wherein the microlens array is laterally offset from the array of sensitive areas on the detector array such that light passes through the microlens array and is incident upon the array of sensitive areas on the detector array.

6. The imaging system for capturing images of a tilted object of claim 1, wherein the imaging system is adapted to capture images of an edge portion of a semiconductor wafer.

7. The imaging system for capturing images of a tilted object of claim 3, and further comprising:
a normalizer positioned between the lens and the detector array for realigning light passing therethrough such that the light transmitted by the normalizer is incident upon the detector array substantially normal to the detector array while simultaneously the image of the tilted object is substantially focused across the area of the detector array.

8. The imaging system for capturing images of a tilted object of claim 7, wherein the normalizer is selected from a group consisting of a simple prism, a complex prism, a grating, a grism, and a combination of one or more of the preceding.

9. The imaging system for capturing images of a tilted object of claim 3, wherein the detector array is positioned normal to an optical axis of the lens.

10. The imaging system for capturing images of a tilted object of claim 3, wherein the detector array is positioned parallel to the lens.

11. The imaging system for capturing images of a tilted object of claim 3, and further comprising:
an illuminator for providing light; and
a diffuser positioned adjacent the object for diffusing the light about the object.

12. The imaging system for capturing images of a tilted object of claim 11, wherein the diffuser includes a slot for receiving a portion of the object.

13. The imaging system for capturing images of a tilted object of claim 11, wherein the diffuser is positioned at an angle α to a radius of the object and the lens is positioned at an angle β to the same radius of the object opposite the angle α.

14. The imaging system for capturing images of a tilted object of claim 13, wherein the angles α and β are substantially the same.

15. The imaging system for capturing images of a tilted object of claim 13, wherein the angles α and β are different.

16. The imaging system for capturing images of a tilted object of claim 1, wherein the detector array has an optical axis that is in a different plane than the object.

17. The imaging system for capturing images of a tilted object of claim 7, wherein the imaging system is adapted to capture images within a substantial field of view under constant surveillance.

18. A camera for capturing images of a tilted object comprising:
a detector array; and
a normalizer for re-aligning light passing therethrough such that the light is incident upon the detector array substantially normal to the detector array while simultaneously the image of the tilted object is substantially focused across the area of the detector array.

19. The camera for capturing images of a tilted object of claim 18, wherein the normalizer is selected from a group consisting of a simple prism, a complex prism, a grating, a grism, and a combination of one or more of the preceding.

20. The camera for capturing images of a tilted object of claim 18, and further comprising:
a lens having an optical axis; and
wherein the detector array is positioned normal to the optical axis of the lens.

21. The camera for capturing images of a tilted object of claim 20, wherein the detector array is positioned substantially parallel to the lens of the camera.

22. The camera for capturing images of a tilted object of claim 18, and further comprising:
a microlens array to concentrate and direct light from the normalizer to the detector array.

23. The camera for capturing images of a tilted object of claim 22, wherein the camera is positioned to capture images of an edge portion of a semiconductor wafer.

24. The camera for capturing images of a tilted object of claim 18, wherein the camera is adapted to capture images within a substantial field of view under constant surveillance.

25. An imaging system for capturing images of a tilted object comprising:
a camera further comprising:
a lens having an optical axis;
a detector array tilted with respect to the optical axis of the lens and positioned to receive light passed through the lens, the angle of tilt of the detector array being related to the tilt of the object being imaged; and,
a normalizer positioned between the lens and the detector array for realigning light passing therethrough such that the light is incident upon the detector array substantially normal to the detector array while simultaneously the image of the tilted object is substantially focused across the area of the detector array;
an illuminator for providing light; and
a diffuser positioned adjacent the object for diffusing the light about the object.

26. A system for inspecting a substrate comprising:
an illuminator arranged to direct light onto an area of the substrate;
an imager positioned on an optical path such that at least a portion of the light from the illuminator incident upon the area of the substrate is incident on the imager, the imager and the area of the substrate being out of planar alignment with one another; and
a normalizer positioned in the optical path between the area of the substrate and the imager, the normalizer being constructed and arranged to modify the light traveling from the area of the substrate to the imager in such a manner that an image of the area of the substrate is substantially in focus on the imager.

27. The system for inspecting a substrate of claim 26, wherein the normalizer comprises a transmissive optical element that refracts light traveling from the area of the substrate to the imager in a such a manner as to satisfy the requirements of the Scheimpflug condition.

28. The system for inspecting a substrate of claim 26, wherein the normalizer comprises an optical element selected from a group consisting of a simple prism, a complex prism, a grating, a grism, and a combination of the foregoing.

29. The system for inspecting a substrate of claim 28, further comprising a transmissive lens positioned on the optical path between the area of the substrate and the imager.

30. The system for inspecting a substrate of claim 29, wherein the lens is positioned between the area of the substrate and the normalizer.

31. The system for inspecting a substrate of claim 29, wherein the normalizer is positioned between the area of the substrate and the lens.

32. The system for inspecting a substrate of claim 29, wherein the lens is combined with the normalizer to form a complex optical element.

33. The system for inspecting a substrate of claim 26, wherein the imager further comprises an array of microlenses positioned on the optical path between the imager and the area of the substrate.

34. The system for inspecting a substrate of claim 33, wherein the array of microlenses positioned on the optical path between the imager and the area of the substrate form a complex optical element with the normalizer.

35. The system for inspecting a substrate of claim 26, wherein the substrate comprises a semiconductor wafer.

36. The system for inspecting a substrate of claim 26, wherein the substrate comprises an edge of a semiconductor wafer.

37. The system for inspecting a substrate of claim 26, further comprising a diffuser positioned adjacent to the substrate for absorbing and remitting at least a portion of the light output by the illuminator, at least a portion of the light output by the diffuser being incident upon the substrate in such a manner as to be reflected along the optical path to the imager.

38. The system for inspecting a substrate of claim 37, wherein the substrate is an edge of a semiconductor wafer and the diffuser further comprises an aperture into which the edge of the semiconductor wafer may be inserted.

39. The system for inspecting a substrate of claim 25, further comprising a plurality of illuminators, each directed at the substrate to provide illumination to the imager in a manner chosen from a group consisting of brightfield illumination, darkfield illumination, and laser illumination.

40. The system for inspecting a substrate of claim 39, wherein at least two of the plurality of illuminators are positioned out of the plane of the substrate being inspected.

41. The system for inspecting a substrate of claim 39, wherein at least one of the plurality of illuminators directs light onto the substrate along an optical path defined, at least in part, by a turning mirror.

42. The system for inspecting a substrate of claim 26, further comprising a plurality of cameras, at least one of which is positioned out of the plane of the substrate.

43. A system for inspecting a substrate comprising:
an illuminator arranged to direct light onto an area of the substrate;
an imager positioned on an optical path such that at least a portion of the light from the illuminator incident upon the area of the substrate is incident on the imager; and,
an imager support to which the imager is affixed, the imager support positioning the imager at an angle with respect to the optical path and the area of the substrate so as to ensure that substantially all of an image of the area of the substrate is focused on the imager.

44. The system for inspecting a substrate of claim 43, wherein the imager further comprises an array of microlenses positioned on the optical path between the imager and the area of the substrate.

45. The system for inspecting a substrate of claim 43, wherein the imager support removably secures the imager at a fixed angle to a camera that supports the imager in the optical path.

46. The system for inspecting a substrate of claim 45, wherein one of a plurality of imager supports, each of which is constructed and arranged to removably secure an imager to a camera at a fixed angle, is selected to ensure that substantially the entire image of the substrate is focused on the imager.

47. The system for inspecting a substrate of claim 44, wherein the array of microlenses is offset with respect to the imager so as to place the respective microlenses of the array directly on the optical path between the area of the substrate and corresponding areas of the imager.

48. The system for inspecting a substrate of claim 43, wherein the imager support rotatably secures the imager at one of a plurality of angles to a camera that supports the imager in the optical path.

49. The system for inspecting a substrate of claim 26, wherein the light transmitted by the normalizer is incident upon the detector array substantially normal to the detector array.
